(19) United States
(12) Patent Application Publication
(10) Pub. No.: US 2014/0313722 A1
(43) Pub. Date: Oct. 23, 2014

(54) Flexible Decorative Lighted Strip, Cabinet Including Same, and Installation Method

(71) Applicant: Raw Thrills, Inc., Skokie, IL (US)

(72) Inventors: Andrew ELOFF, Evanston, IL (US); Eugene JARVIS, Glenview, IL (US); Robert YOEST, Northbrook, IL (US)

(73) Assignee: Raw Thrills, Inc., Skokie, IL (US)

(21) Appl. No.: 14/254,241

(22) Filed: Apr. 16, 2014

Related U.S. Application Data
(60) Provisional application No. 61/812,809, filed on Apr. 17, 2013.

(51) Int. Cl. F21V 21/32; F21S 4/00

(52) U.S. Cl. CPC F21V 21/32; F21S 4/005
USPC 362/249.04; 362/418; 29/592.1

(57) ABSTRACT

A flexible lighting strip in the form of a T-molding covers a board edge of a video or arcade game cabinet, allowing decorative lighting to be applied to the cabinet. The T-molding includes a flexible casing having a head portion with an upper surface formed of a transparent or translucent plastic material, and a hollow channel formed in the head portion that extends along the casing. The channel accommodates insertion of a flexible lighting strip formed of a flexible printed circuit board substrate with light emitting diodes mounted on the substrate, so emitted light shines through the transparent upper surface of the casing. The casing has an anchor strip for insertion into a groove formed in the cabinet board edge to anchor the casing to the board edge via frictional engagement. A method is provided for applying the lighted T-molding to a video or arcade game cabinet.

### CROSS-REFERENCE TO RELATED APPLICATIONS

This application claims the benefit of U.S. Provisional Application No. 61/812,809, filed Apr. 17, 2013, and said provisional application and all contents thereof are hereby incorporated by reference herein, in their entirety.

### BACKGROUND OF THE INVENTION

The coin-operated arcade and video game industry is approximately 40 years old. Although it is a mature industry from the standpoint that there is a large installed base of arcade and video games around the world, there is always the possibility that a new, highly sought after, high earning game will reinvigorate the market for a new product. In order to sell new games, besides the demand for replacement of older, dilapidated equipment, these games need to attract surplus revenue with respect to the existing equipment already installed at a particular location. Further, this surplus revenue must be sufficiently high to pay for the new equipment and provide profit net of operating costs within a reasonable portion of the expected lifetime of the game.

One of the objects of this invention is to take advantage of all necessary innovations to providing novel, desirable, yet cost effective coin-operated arcade or video games in cabinets that attract game players.

In recent years the intensity of light emitting diodes (LEDs) has increased dramatically while at the same time the cost of the manufacture has dropped significantly. This has made it possible to create eye-catching visual adjuncts to video game entertainment to help attract game players. For example, large arrays of LEDs can create a sense of motion, modulate the sense of tension or excitement, or otherwise enhance the mood of the game.

Installation of LED arrays must capture and present the LEDs in a durable, reliable, highly visible manner. As such, LED installations require at least the following: a circuit that connects the LEDs to a power and optionally a control source, the ability to conform the array to the arbitrary shapes in at least one axis, and a protective covering or coating to prevent damage to the LEDs or the connecting circuitry.

Currently there are several techniques used to implement linear LED arrays. The “Great Wall” LED array strip captures LEDs and their circuitry in a soft material via “potting” or immersion into plastic. These strips can bend in an axis perpendicular to the radiated light. These circuits can be exposed to the environment, but they still need to be captured in some way, particularly for protection from damage. Typically this is done through bracketry that sandwiches the array behind a bezel. Otherwise, the array may be pushed into a transparent or translucent casing from the rear side.

Newer technology has facilitated the creation of what are known as LED tape strips, hereinafter referred to as “LED strips”. These LED strips have a flexible printed circuit board (“PCB”) substrate and conform much better to arbitrary surfaces and do so in a wide axis of radiation which leads to a wider variety of potential installations. However, capturing and mounting these LED strips provides significant challenges. Although LED strips can be protected from the environment via potting, capturing techniques require the additional significant expense of the bands and do not lend themselves well to the same techniques as the Great Wall strips.

Currently, the most cost-effective construction of an arcade game typically utilizes machined engineered wood products such as medium density fiber board (MDF) or particleboard. These boards are machined to shapes and assembled by abutting the edges of boards into a generally box shape. One result of these abutments is the exposure of the machined edges of the boards. These edges are unsightly and prone to damage, so a protective surface is typically installed. Currently, a plastic extruded product referred to as “T-molding” is used. The cross section of a typical, generally commercially available prior art T-molding is shown in FIG. 2 of the drawings.

Usually the cabinet is constructed such that the T-molding is at least on the front left and right vertical edges of the cabinet. Some manufacturers have used black colored T-molding to minimize the visual interruption. Later, chrome colored T-molding has been used to add some visual flair to the edges of the cabinet. This particular feature has proven to be so popular that some companies now use chrome T-molding on virtually all of their game cabinets.

Other manufactures have created a game cabinet that features LED lighting that runs the entire height of the cabinet on the left and right edges. In order to accomplish that design, a clear plastic piece was sandwiched between the cabinet wall on the inside and a metal plate on the outside. Then the LED tape was installed behind the clear plastic pointed outwardly. While this construction is visually compelling, it is also exorbitantly expensive as the sidewalls of the cabinet essentially became a three-ply wall consisting of layers of wood, plastic and metal.

### BRIEF SUMMARY OF THE INVENTION

To provide a cost-effective yet better-performing decorative lighted strip in the form of T-molding for cabinets for arcade games incorporating LEDs, one aspect of the invention herein includes a T-molding that incorporates an LED strip within a hollow channel formed in a flexible, extruded T-molding casing having a translucent or transparent upper surface that allows display of the LED-generated light through the casing while also protecting the LED strip from damage arising from environmental exposure to elements such as physical impact and liquids. Another aspect of the invention includes the described T-molding casing provided without the LED strip in order to allow the user flexibility to provide lighting means of the user's choice within the hollow channel. Another aspect of the invention includes cabinets for arcade or video games incorporating T-molding casings having the hollow channel with LED strip. The invention provides benefits lacking in the prior art devices in that the invention allows for flexibility and cost-effectiveness in the installation, repair, and replacement of the T-molding and the LEDs, as well as flexibility and cost-effectiveness in programming and controlling the light displays that prior art devices have failed to provide.

### BRIEF DESCRIPTION OF THE SEVERAL VIEWS OF THE DRAWINGS

FIG. 1 is a cross-sectional view taken along line I-I′ of FIG. 9, of an embodiment of the invention with an LED strip.

FIG. 2 is a cross-sectional view of a prior art T-molding.

FIG. 3 is a front elevational view of a diagram of an LED strip.

FIG. 4 is a top view of a diagram of an LED strip.

FIG. 5 is a cross-sectional view taken along line II-II′ of FIG. 7, of an embodiment of the invention without an LED strip.

FIG. 6 is a perspective view of an embodiment of the invention without an LED strip.

FIG. 7 is a top view of an embodiment of the invention without an LED strip.

FIG. 8 is a bottom view of an embodiment of the invention without an LED strip.

FIG. 9 is a perspective view of an embodiment of the invention with an LED strip.

FIG. 10 is a side elevational view of an embodiment of the invention with a coextruded portion.

### REFERENCE NUMERALS

1 prior art T-molding
10 casing of T-molding
12 anchor strip of T-molding
13 barbs of anchor strip
14 head portion of T-molding
15 coextruded portion of T-molding
16 channel formed in T-molding
18 top surface of T-molding
20 LED strip
22 substrate of LED strip
24 LED (light emitting diode) of LED strip
26 controller chip of LED strip

### DETAILED DESCRIPTION OF THE INVENTION

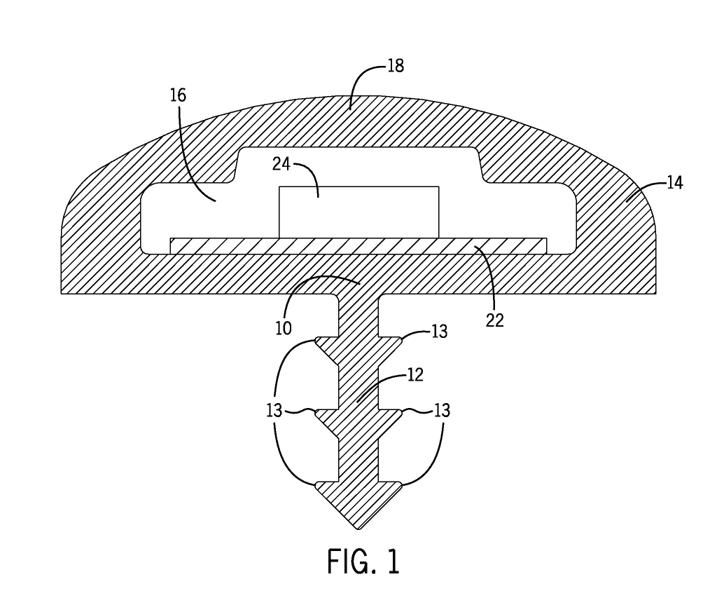

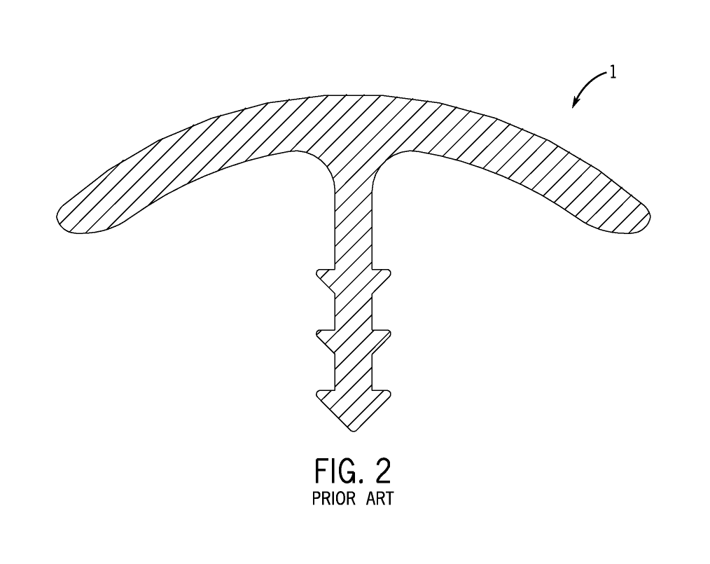

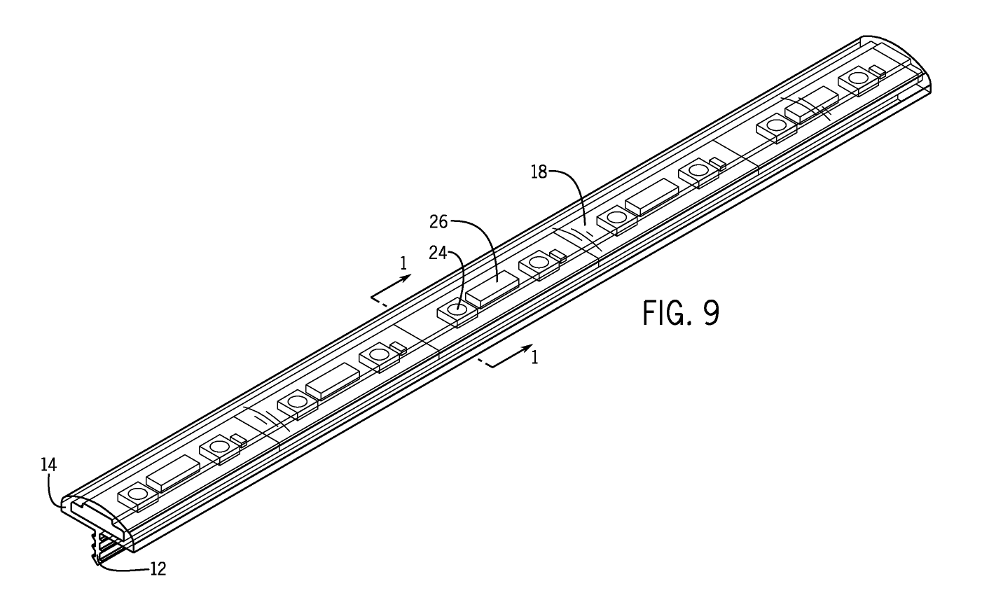

An aspect of the invention includes a flexible T-molding provided in an elongated form as generally depicted in FIG. 9. A cross-sectional view of a typical, generally commercially available prior art T-molding 1 is shown in FIG. 2, which is contrasted to the cross-sectional view of the claimed T-molding shown in FIG. 1. As shown in FIG. 1, the invention includes a housing or casing 10 having a head portion 14 which has an outer upper surface that is preferably formed to have a flat, domed, or flattened-dome shape as shown in FIG. 1, but can be any suitable shape adapted to the particular installation as desired. The head portion 14 includes a hollow channel 16 surrounded by the head portion 14, formed along the entire length along a longitudinal axis of the T-molding, and shaped to accommodate insertion of a flexible lighting strip.

The T-molding casing 10 can preferably include an anchor strip portion 12 integrally molded with and extending downwardly from a lower or bottom surface of the head portion 14 and formed along the entire length of the T-molding, shaped and adapted to form an attachment between the T-molding and the board of the game cabinet. The pointed anchor strip 12 generally includes a number of outwardly extending flanges or flange-like projections that form laterally-extending barbs 13, 13 (as shown in a cross-sectional view in FIG. 1) provided at intervals along the lateral sides of the anchor strip 12. The anchor strip 12 is shaped and adapted to be inserted into a groove formed in the cabinet edge. The flanges extend along the length of the anchor strip 12 along the longitudinal axis of the casing, with the flange ends being shaped and adapted to serve as barbs that abut sides of the groove formed in the cabinet edge, so as to anchor the anchor strip in the groove by means of a tight frictional engagement between the barbs and the sides of the groove in the board.

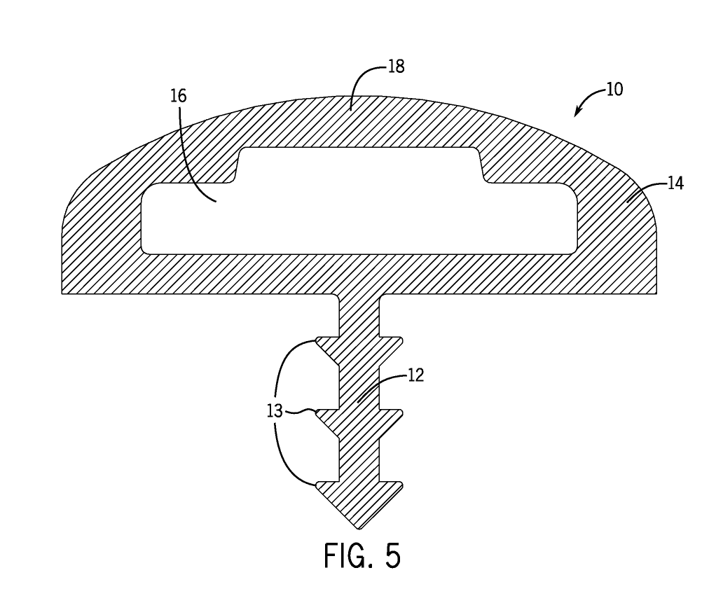

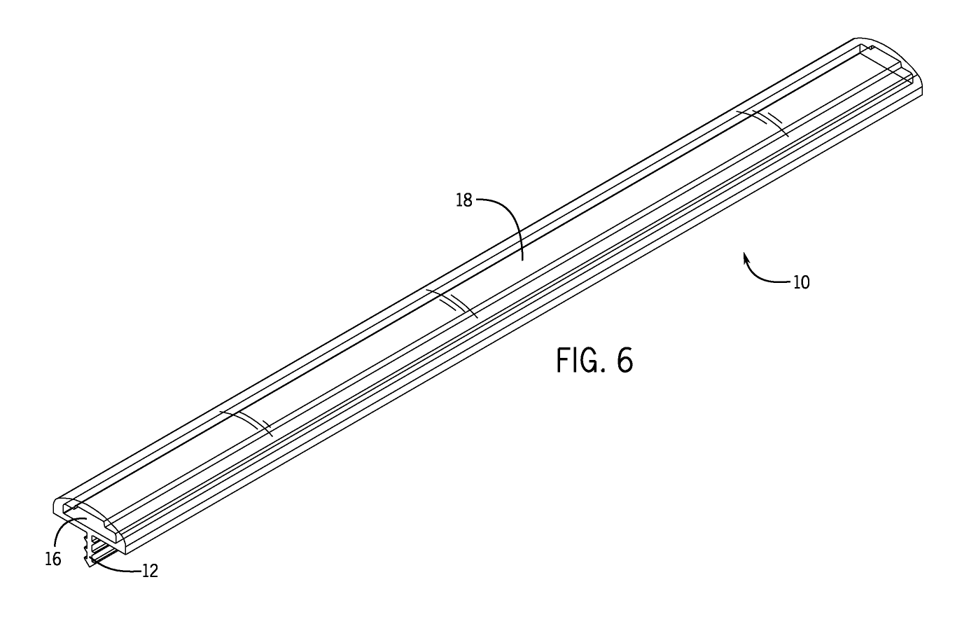

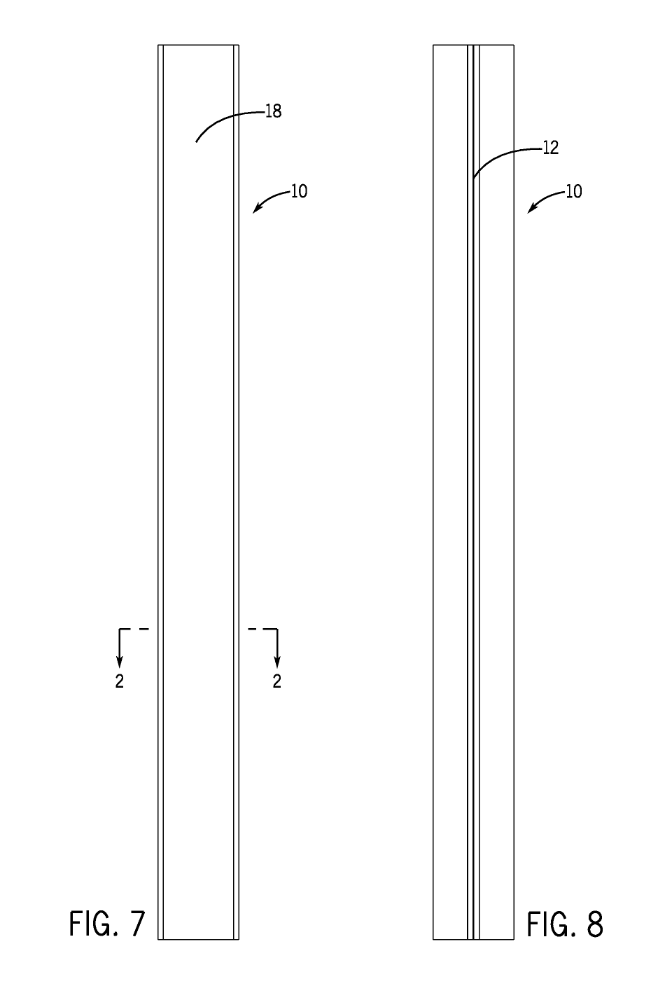

As shown in FIG. 9, the T-molding casing 10 is preferably formed of a clear flexible material such as plastic. The T-molding casing is preferably formed by extrusion. The T-molding casing 10 in its top or upper surface area 18 of the head portion 14 should be as transparent or translucent as possible so as to allow light emitted by the LEDs within the channel 16 to transmit through the top surface 18 of the head portion 14 so that the emitted light is visible outside the T-molding casing 10. Translucent or transparent material having coloring can be employed. Other views of the casing 10 are shown in FIGS. 5-8.

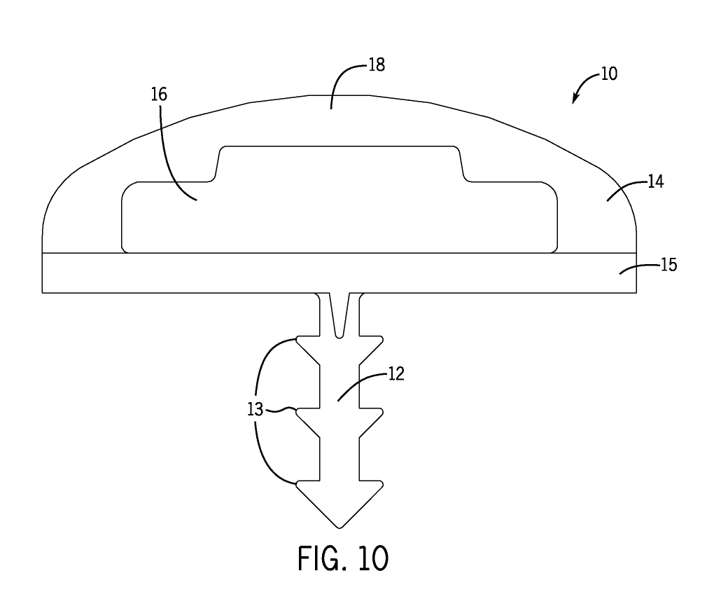

Another aspect of the invention is depicted in FIG. 10, wherein the head portion 14 includes the top surface area 18 which is as transparent or translucent as possible, and also includes a coextruded portion 15. The coextruded portion 15 is formed of a material different from that of the top or upper surface area 18, or is formed of a material that has a different color, opacity, or hardness from that of the top or upper surface area 18. The co-extruded portion 15 thus can preferably be made of a secondary plastic material that is different from or has different physical characteristics than those of the plastic material of the upper surface 18. Accordingly the co-extruded portion 15 can have characteristics that differ from those of the transparent area 18, as desired, such as higher opacity to provide a solid background to the LEDs offering a different visual effect; different coloration to provide a different decorative effect; higher degree of hardness to suit physical demands of a particular installation; or higher resistance to heat degradation or deformation to enhance product operational life.

The flexible lighting strip is preferably an LED strip 20 that includes light emitting diodes (LEDs) 24 which provide light and can be programmed to provide a variable light display. The LED strip 20 includes a flexible substrate 22 on which are formed LEDs 24 and controller chips 26. The LED strip 20 preferably is formed of a flexible printed circuit board (PCB) substrate 22 containing circuitry allowing for varied programming of the patterns, timing, and coloring of the light emissions generated by the LEDs 24. The LED strip 20 typically will include means for connection at one or both of its ends for connecting the LED strip 20 to a power source, to a controller for programming its light display, and/or to other LED strips.

The installation of the T-molding is accomplished as follows. The edges of any cabinet boards where the T-molding is to be installed need to have a groove or channel machined in to them, in a direction perpendicular to the edge and along the longitudinal axis of the edge. The groove typically can be machined in using a router.

Then, starting on one end, the casing 10 as shown in FIGS. 5-8 without the LED strip 20 is installed. The casing 10 is typically provided in pieces having lengths of about five to seven feet, depending on the length needed for the installation in question. The casing 10 is installed onto the board edge by placing the anchor strip 12 bearing the flanges that form the barbs 13 onto the board edge and pushing the anchor strip 12 into the groove or channel in the cabinet board edge. The anchor strip 12 can be pushed into place in the groove by pounding or hammering on the upper surface of the casing 10 using a hammer or mallet, so that the barbs 13 enter and engage with the sides of the groove, and thus hold the T-molding casing 10 in place by forming a tight frictional engagement between the barbs 13 and the sides of the groove. This pounding-in continues along the length of the T-molding casing 10 from the starting end to the finishing end. Any extra length of the T-molding casing 10 is then cut off.

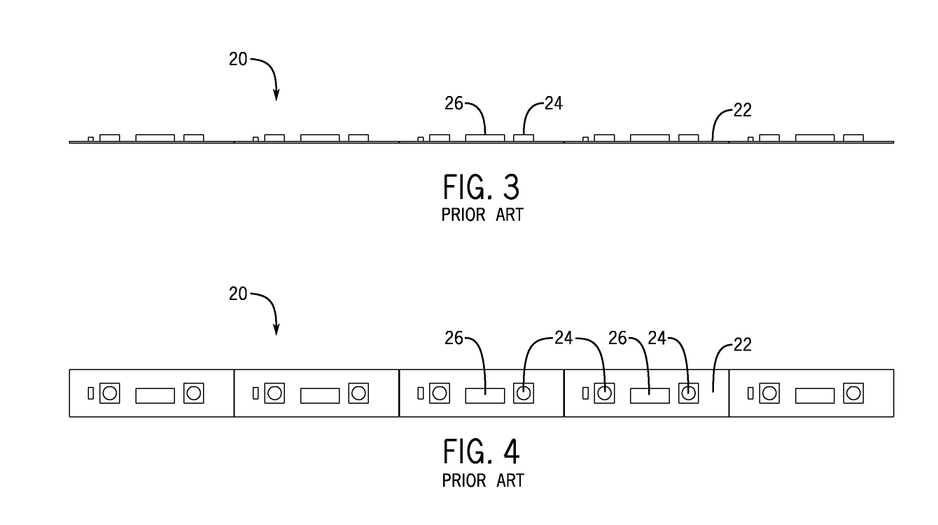

Then, an LED strip 20 (a portion of which is shown in a general diagram in FIGS. 3 and 4) is inserted into an end of the channel 16 formed in the casing 10 and is fed into the channel 16. The insertion can be accomplished by a number of means. A preferred means is to push the LED strip 20 into the channel 16 and continue pushing so as to feed the LED strip 20 all the way along the length of the channel 16 by pushing force. However, because the LED strip 20 might not be sufficiently rigid to be pushed all the way through the channel 16, another preferred means is to attach a leading end of the LED strip 20 to the leading end of a carrier, using double-sided tape or other affixing means. The carrier preferably is a thin, flat, flexible strip of plastic or other suitable material that is rigid in its longitudinal direction but can bend slightly in vertical directions toward its upper and lower surfaces, in order to follow bends in the channel 16. The carrier is sufficiently narrow to be inserted into the channel 16. The carrier is attached to the bottom side of the LED strip 20 on their leading ends. These leading ends are then inserted and fed into the channel 16, whereby the LED strip is pulled through the channel by the leading end of the carrier until the entire length of the channel 16 contains the LED strip 20 borne on the carrier. In a preferred aspect of the invention, the leading end of the carrier strip is then detached from the leading end of the fed-through LED strip 20 and the carrier is removed from the channel by pulling while the LED strip 20 is held in place within the channel 16. In another preferred aspect of the invention, the carrier is left inside the channel 16 with the LED strip 20, so that the carrier can be used later to facilitate easy removal of the LED strip 20 for repair or replacement.

A power source is preferably connected to the LED strip 20 at one or more ends of the T-molding as desired. An optional control means for controlling the light display of the LEDs can be connected to the LED strip 20 at one or more ends of the T-molding as desired. To finish the ends of the T-molding, a metal bracket (or cap) is then installed on ends of the T-molding to prevent the LED strip 20 from being removed and to protect the exposed wires at the end of the LED strip 20.

When installed in the boards of a game cabinet (not shown in the drawings), the head portion 14 of the T-molding then protects the edge of the board by providing a smooth, durable, liquid-resistant edging to the board and providing a finished look.

In arriving at the claimed solution, the inventors determined that it would not be generally satisfactory to pot (immerse or embed) LED strips into the plastic of the T-molding. This is because, as the T-molding is flexed to accommodate curved edge shapes of the game cabinet, for example, the LED strips would flex at a different radius than the T-molding, and either stretch, compress, or bend the circuit in the LED strip, and accordingly, damage the circuit and the LED strip. And so the inventors developed the present invention utilizing the new extruded clear plastic T-molding casing 10 with a hollow channel 16 down the middle as shown in FIGS. 2 and 9. The LED strip 20 which includes LEDs 24 and chips 26 supported on flexible PCB substrate 22 is inserted into the hollow channel 16 in the middle of the T-molding casing 10 as described in the preceding paragraphs.

In one aspect of the invention, the LED strip 20 is contained within the channel 16 but is not physically attached to the interior of the T-molding casing 10 along the longitude of the T-molding. The LED strip 20 lies within the channel 16 with some freedom of movement independent of that of the T-molding, and no glue or other attachment is made between the LED strip 20 and the inside walls of the hollow channel 16 along the longitude. Thus, the assembly protects the LED strip 20 from damage that would be caused when a T-molding was bent, stretched, or compressed, because the assembly allows the LED strip 20 more freedom to bend on an axis independent of that of the T-molding. The assembly allows the LEDs 24 to shine brightly through the transparent upper surface 18 of the plastic T-molding while also protecting the LED strip 20.

This protection is most notable in that, in an aspect of the invention, the assembly provides for simple installation of the T-molding onto the cabinet by pounding the T-molding casing 10 onto the cabinet edge using a hammer or mallet to drive the anchor strip 12 of the T-molding casing 10 into the groove or channel that was machined into the edge of the cabinet board. The pounding-in occurs before insertion of the LED strip 20, so that the LED strip 20 is not damaged during the pounding-in.

Another key benefit arising from the invention is the ability to easily slide the LED strip 20 out of the channel 16 of the T-molding casing 10 for service or replacement. The user has the option to repair or replace the LED strip without removing the installed T-molding casing 10, and then easily slide the LED strip 20 back in.

Another key benefit is that the channel 16 of the T-molding casing 10 acts generally as a protective open space surrounding the LED strip 20. The channel 16 preferably has a shape that accommodates the inserted LED strip 20 and also provides open space at the sides and above the upper surface of the LED strip 20. Unlike prior art devices, this airspace generally prevents T-molding material from coming into direct contact with the LEDs 24 and controller chips 26 themselves. This greatly assists in preventing material degradation of the casing 10 and the LEDs and chips 24, 26, that would be caused by direct contact between them that yields abrasive effects, compression effects, and the like. The open space or air pocket also allows for cooling so as to reduce degradation and discoloration of the casing 10 caused by heat generated by the LED strip 20, and can extend the operational life of the LED strip 20 and its components LEDs 24 and chips 26 by providing this space that allows heat from the LEDs to dissipate.

It will be understood by those skilled in the art that key benefits provided by the invention consisting or consisting essentially of the casing 10, and also by combination of the casing 10 with LED strips 20, as designed by the inventors herein is the simplicity and economy provided by the casing design, its combination with known LED strips, and its ease and flexibility in installation, removal and repair. Thus, one aspect of the invention could preferably entail the exclusion of elements not specifically disclosed herein. Such excluded elements could, in certain circumstances, impair the cost-effectiveness of the claimed invention by introducing parts or steps that increase costs and decrease the simplicity of installation, operation, and repair of the claimed invention. The invention as illustratively disclosed herein suitably may be practiced in the absence of any element which is not specifically disclosed herein.

The foregoing detailed description has been given for clearness of understanding only and no unnecessary limitations should be understood therefrom as some modifications would be obvious to those skilled in the art. The above-described embodiments of the present invention have been provided to illustrate various aspects of the invention. However, it is to be understood that different aspect of the invention shown in different specific embodiments can be combined to provide other embodiments of the invention. Accordingly, the invention is to be limited solely by the scope of the claims.

What is claimed is:

1. A T-molding for covering a cabinet edge, comprising:
an extruded flexible casing, wherein said casing comprises a head portion having an upper surface that is formed of a transparent or translucent plastic material, and a hollow channel formed in the head portion that extends along a longitudinal axis of the casing, wherein the hollow channel is shaped to accommodate insertion of a flexible lighting strip.

2. The T-molding according to claim 1, further comprising a flexible lighting strip inserted into the channel, wherein the flexible lighting strip is a light emitting diode strip comprising a flexible printed circuit board substrate and a plurality of light emitting diodes mounted on the substrate.

3. The T-molding according to claim 1, wherein
the casing further comprises an anchor strip integrally molded with and downwardly extending from a bottom surface of the head portion of the casing, and
said anchor strip is shaped and adapted to be inserted into a groove formed in the cabinet edge, and comprises at least one flange extending in a lateral direction outwardly from a side of the anchor strip along the longitudinal axis of the casing, said flange being shaped and adapted to abut sides of the groove formed in the cabinet edge so as to anchor the anchor strip in the groove.

4. The T-molding according to claim 2, wherein the casing further comprises an anchor strip integrally molded with and downwardly extending from a bottom surface of the head portion of the casing, and
said anchor strip is shaped and adapted to be inserted into a groove formed in the cabinet edge, and comprises at least one flange extending in a lateral direction outwardly from a side of the anchor strip along the longitudinal axis of the casing, said flange being shaped and adapted to abut sides of the groove formed in the cabinet edge so as to anchor the anchor strip in the groove.

5. The T-molding according to claim 1, wherein the casing comprises a co-extruded portion formed in a lower part of the head portion of the casing below the hollow channel, and wherein said co-extruded portion is formed of a secondary plastic material that is different from or has different physical characteristics than those of the plastic material of the upper surface of the head portion.

6. The T-molding according to claim 2, wherein the casing comprises a co-extruded portion formed in a lower part of the head portion of the casing below the hollow channel, and wherein said co-extruded portion is formed of a secondary plastic material that is different from or has different physical characteristics than those of the plastic material of the upper surface of the head portion.

7. The T-molding according to claim 4, wherein the casing comprises a co-extruded portion formed in a lower part of the head portion of the casing below the hollow channel, and wherein said co-extruded portion is formed of a secondary plastic material that is different from or has different physical characteristics than those of the plastic material of the upper surface of the head portion.

8. A video or arcade game cabinet comprising a T-molding according to claim 1.

9. A video or arcade game cabinet comprising a T-molding according to claim 2.

10. A video or arcade game cabinet comprising a T-molding according to claim 3.

11. A video or arcade game cabinet comprising a T-molding according to claim 4.

12. A video or arcade game cabinet comprising a T-molding according to claim 5.

13. A video or arcade game cabinet comprising a T-molding according to claim 6.

14. A video or arcade game cabinet comprising a T-molding according to claim 7.

15. A method for applying decorative lighting to a video or arcade game cabinet, comprising:
forming a groove in an edge of a cabinet board of the cabinet;
providing a T-molding for covering the board edge, said T-molding comprising an extruded flexible casing comprising a head portion having an upper surface that is formed of a transparent or translucent plastic material, and a hollow channel formed in the head portion that extends along a longitudinal axis of the casing, wherein the hollow channel is shaped to accommodate insertion of a flexible lighting strip, wherein the casing comprises an anchor strip integrally molded with and downwardly extending from a bottom surface of the head portion of the casing, said anchor strip being shaped and adapted to be inserted into a groove formed in the cabinet edge and comprising at least one flange extending in a lateral direction outwardly from a side of the anchor strip along the longitudinal axis of the casing, said flange being shaped and adapted to abut a side of the groove formed in the cabinet edge so as to anchor the anchor strip in the groove via frictional engagement between the flange and the side of the groove;
aligning the anchor strip of the casing along the groove of the board edge;
pushing upon the upper surface of the casing so as to force the anchor strip into the groove of the board edge so that the at least one flange of the anchor strip abuts a side of the groove and forms a frictional engagement between the groove and the anchor strip, thereby affixing the casing to the board;
inserting and feeding the flexible lighting strip into the channel, wherein the flexible lighting strip is a light emitting diode strip comprising a flexible printed circuit board substrate and a plurality of light emitting diodes mounted on the substrate; and
connecting a power source to an end of the lighting strip.

16. The method according to claim 15, wherein the inserting step comprises attaching a leading end of the lighting strip to a leading end of a carrier strip and feeding the carrier strip with the attached lighting strip into the channel.
